(19) United States
(12) Patent Application Publication
(10) Pub. No.: US 2016/0303923 A1
(43) Pub. Date: Oct. 20, 2016

(54) Method for Manufacturing Pneumatic Tire

(71) Applicant: THE YOKOHAMA RUBBER CO., LTD., Tokyo (JP)

(72) Inventors: Atsushi Tanno, Hiratsuka-shi (JP); Jun Matsuda, Hiratsuka-shi (JP); Takashi Hoshiba, Hiratsuka-shi (JP)

(21) Appl. No.: 15/101,271

(22) PCT Filed: Dec. 3, 2013
(86) PCT No.: PCT/JP2014/081942

§ 371 Date: Jun. 2, 2016

(30) Foreign Application Priority Data
Dec. 3, 2013 (JP) 2013-250540
Sep. 4, 2014 (JP) 2014-180125

(51) Int. Cl. B60C 19/00; B29C 65/48; B29D 30/00; B29D 30/06; B29D 30/30

(52) U.S. Cl. CPC B60C 19/002; B29D 30/0662; B29D 30/0681; B29D 30/3007; B29D 30/0061; B29C 65/48; B29D 2030/0682; B29K 2677/00

(57) ABSTRACT

A method for manufacturing the pneumatic tire according to the present technology includes the steps of: molding a green tire that includes an inner liner member; attaching a film to a region on the inner surface of the green tire corresponding to a tread portion, by adhesive force of the inner liner member; coating the inner surface of the green tire that includes the film with a mold release agent; vulcanizing the green tire coated with the mold release agent; removing the film from the inner surface of a pneumatic tire obtained through the vulcanization; and bonding a belt-shaped sound-absorbing member, via an adhesive layer along the tire circumferential direction, to an exposed region from which the film has been peeled off.

### TECHNICAL FIELD

The present technology relates to a method for manufacturing a pneumatic tire in which a belt-shaped sound-absorbing member is bonded to a region on a tire inner surface corresponding to a tread portion, and more specifically relates to a method for manufacturing a pneumatic tire that makes it possible to easily remove a mold release agent from the region on the tire inner surface to which the sound-absorbing member is bonded, and as a result, suppresses a separation of the sound-absorbing member.

### BACKGROUND ART

In pneumatic tires, cavernous resonance caused by the vibration of air with which the tire is filled is one cause of noise generation. When a tire is rolled, uneven road surfaces cause a tread portion to vibrate. The vibrations of the tread portion cause the air inside the tire to vibrate, which causes cavernous resonance to be generated.

As a way to reduce the noise caused by the cavernous resonance, a method has been proposed in which a sound-absorbing member is disposed inside a space formed between a tire and the rim of a wheel. More specifically, a belt-shaped sound-absorbing member is bonded to a region on the tire inner surface corresponding to the tread portion (see Japanese Unexamined Patent Application Publication Nos. 2002-67608A and 2005-138760A, for example).

However, there has been a problem in which, because a mold release agent, which is used at a time of vulcanization, is attached to the inner surface of the pneumatic tire, the sound-absorbing member is easily separated from the tire inner surface due to the effect of the mold release agent. In response to this, a method has been proposed in which the tire inner surface is polished with a surface finishing device before bonding the sound-absorbing member, and the sound absorbing member is bonded to a region on which the polishing processing has been performed (see Japanese Unexamined Patent Application Publication No. 2007-168242A, for example). However, when the tire inner surface is polished, there is a risk that an inner liner layer disposed on the tire inner surface may be damaged. Thus, this method is not necessarily preferable. Further, it is conceivable to wipe off the mold release agent attached to the tire inner surface, using a cloth, before bonding the sound-absorbing member. However, the operation of wiping off the mold release agent from the tire inner surface requires a lot of labor, and in addition, it is difficult to remove the mold release agent cleanly.

### SUMMARY

The present technology provides a method for manufacturing a pneumatic tire that makes it possible to easily remove a mold release agent from a region on a tire inner surface corresponding to a tread portion to which a sound-absorbing member is bonded when a belt-shaped sound-absorbing member is bonded to the region, and as a result, suppresses a separation of the sound-absorbing member.

A method for manufacturing a pneumatic tire according to the present technology includes the steps of: molding a green tire that includes an inner liner member; attaching a film to a region on the inner surface of the green tire by adhesive force of the inner liner member, the region corresponding to a tread portion; coating the inner surface of the green tire with a mold release agent, the green tire including the film; vulcanizing the green tire coated with the mold release agent; removing the film from the inner surface of a pneumatic tire obtained through the vulcanization; and bonding a belt-shaped sound-absorbing member, via an adhesive layer along a tire circumferential direction, to an exposed region from which the film has been peeled off.

Further, a method for manufacturing a pneumatic tire according to the present technology includes the steps of: disposing a film on a molding drum; winding a sheet-shaped inner liner member on the film and attaching the film to a region on the inner liner member by adhesive force of the inner liner member, the region corresponding to a tread portion; molding a green tire that includes the inner liner member, the inner liner member being layered so that the film is positioned on a tire inner surface; coating the inner surface of the green tire with a mold release agent, the green tire including the film; vulcanizing the green tire coated with the mold release agent; removing the film from the inner surface of a pneumatic tire obtained through the vulcanization; and bonding a belt-shaped sound-absorbing member, via an adhesive layer along a tire circumferential direction, to an exposed region from which the film has been peeled off.

Furthermore, a method for manufacturing a pneumatic tire according to the present technology includes the steps of: attaching a film to a region on a sheet-shaped inner liner member by adhesive force of the inner liner member, the region corresponding to a tread portion; molding a green tire that includes the inner liner member, the inner liner member being layered so that the film is positioned on a tire inner surface; coating the inner surface of the green tire with a mold release agent, the green tire including the film; vulcanizing the green tire coated with the mold release agent; removing the film from the inner surface of a pneumatic tire obtained through the vulcanization; and bonding a belt-shaped sound-absorbing member, via an adhesive layer along a tire circumferential direction, to an exposed region from which the film has been peeled off.

### Advantageous Effects of Technology

In the present technology, the following steps are performed: preparing a green tire in which a film is attached to a region on a tire inner surface corresponding to a tread portion by adhesive force of an inner liner member, coating the inner surface of the green tire including the film with a mold release agent, vulcanizing the green tire coated with the mold release agent, removing the film from the inner surface of a pneumatic tire obtained through the vulcanization, and bonding a sound-absorbing member, via an adhesive layer, to an exposed region from which the film has been peeled off. Thus, it is possible to easily remove the mold release agent from the region on the tire inner surface to which the sound-absorbing member is bonded. This makes it possible to inhibit the adhesive strength of the mold release agent from being decreased and to effectively suppress a separation of the sound-absorbing member. As a result, a noise reduction effect based on the sound-absorbing member can be maintained for a long period of time.

After molding the green tire, the above-described film can be attached to the region on the inner surface of the green tire corresponding to the tread portion. However, the film is preferably attached to the inner liner member in the molding step of the green tire. More specifically, it is preferable to dispose a film on a molding drum, wind a sheet-shaped inner liner member on the film and attach the film to a region on the inner liner member corresponding to a tread portion by adhesive force of the inner liner member, and mold a green tire including the inner liner member, the inner liner member being layered so that the film is positioned on the tire inner surface. Alternatively, it is preferable to attach a film to a region on the sheet-shaped inner liner member corresponding to the tread portion by adhesive force of the inner liner member and mold a green tire including the inner liner member, the inner liner member being layered so that the film is positioned on the tire inner surface. When the film is attached to the inner liner member in the molding step of the green tire in this manner, it is possible to secure sufficient adhesiveness between the film and the inner liner member, and it is thus possible to inhibit the film from being separated before the vulcanization step.

A polymer forming the film preferably contains nylon 6. The film containing the nylon 6 has the best balance between adhesive strength with respect to the inner liner member formed of unvulcanized rubber and ease of peeling after vulcanization.

The thickness of the film after vulcanization is preferably from 10 μm to 120 μm. Accordingly, it is possible to achieve both the ease of peeling of the film after vulcanization and a following capability of the film with respect to a deformation of the tire that occurs during the molding step.

It is preferable that the film be disposed so that end portions of the film in the tire circumferential direction overlap with each other, and the overlapping be maintained even after vulcanization. In this case, it is possible to reliably inhibit the mold release agent from penetrating from a splice portion of the film, and further, by grasping one of the overlapped end portions, it is possible to easily perform a peeling-off operation of the film after vulcanization.

Alternatively, it is preferable that the film be disposed so that a missing portion is formed at at least one section in the tire circumferential direction before vulcanization. In this case, the mold release agent is locally attached to the missing portion. Then, when the sound-absorbing member is bonded to the tire inner surface so as to extend over the missing portion, the missing portion becomes a non-adhering region despite the existence of the adhesive layer, and sections on both sides of the missing portion in the tire circumferential direction become adhering regions. More specifically, by forming the missing portion in at least one section of the film in the tire circumferential direction, the adhering region on the sound-absorbing member can be divided in the tire circumferential direction. As a result, it is possible to alleviate shearing strain arising in the adhering surface of the sound-absorbing member and to suppress the separation of the sound-absorbing member.

It is preferable that cutting angles at both the end portions of the film in the tire circumferential direction be from 50 degrees to 80 degrees with respect to the tire circumferential direction. Accordingly, the film can easily follow inflation during the molding step, and it is thus possible to maintain good adhesiveness of the film.

Further, it is preferable that the cutting angles at both the end portions of the film in the tire circumferential direction be identical. In this case, it is possible to efficiently supply the film that is cut with the identical cutting angles at both the end portions in the tire circumferential direction, and it is thus possible to improve productivity of the pneumatic tire.

It is preferable that the sound-absorbing member be formed by one sound absorbing material extending in the tire circumferential direction, that the sound-absorbing member have a uniform thickness at least over a range corresponding to an adhering surface along a cross section orthogonal to a longitudinal direction of the sound-absorbing member, and that the shape of the cross section be constant in the longitudinal direction. Accordingly, it is possible to maximize the volume of the sound-absorbing member per adhering area and to achieve an excellent noise reduction effect. Further, because it is easy to process the sound-absorbing member having the above-described shape, manufacturing costs are also low.

It is preferable that a volume ratio of the sound-absorbing member with respect to the volume of a space formed inside the tire when the tire is assembled to a rim be larger than 20%. By making the volume of the sound-absorbing member large in this manner, it is possible to achieve an excellent noise reduction effect, and further, it is possible to maintain a good adhering state for a long period of time even with the large sound-absorbing member. The volume of the space is a volume of space formed between the tire and the rim in a state in which the tire is assembled to a regular rim and inflated to a regular inner pressure. “Regular rim” is a rim defined by a standard for each tire according to a system of standards that includes the standards on which the tires are based, and refers to a “standard rim” in the case of JATMA (Japan Automobile Tyre Manufacturers Association), to a “Design Rim” in the case of TRA (the Tire and Rim Association), and to a “Measuring Rim” in the case of ETRTO (European Tyre and Rim Technical Organisation). However, when the tire is to be mounted to a new vehicle, the volume of the space is calculated using a genuine wheel to which the tire is assembled. “Regular inner pressure” is the air pressure defined by a standard for each tire according to a system of standards that includes the standards on which the tires are based, and refers to a “maximum air pressure” in the case of JATMA, to a maximum value in the table of “TIRE ROAD LIMITS AT VARIOUS COLD INFLATION PRESSURES” in the case of TRA, and to an “INFLATION PRESSURE” in the case of ETRTO. However, when the tire is to be mounted to a new vehicle, an air pressure indicated in the vehicle is used as the regular inner pressure.

It is preferable that hardness of the sound-absorbing member be from 60 N to 170 N, and tensile strength of the sound-absorbing member be from 60 kPa to 180 kPa. The sound-absorbing member that has the above-described physical properties has excellent durability with respect to shearing strain. The hardness of the sound-absorbing member is measured according to Japanese Industrial Standard JIS-K6400-2 “Flexible cellular polymeric materials—Physical properties—Part 2: Determination of hardness and stress-strain characteristics in compression”, and is measured based on the method D thereof (a method for calculating the force obtained 20 seconds after starting to apply a constant compression of 25%). Further, the tensile strength of the sound-absorbing member is measured according to JIS-K6400-5 “Flexible cellular polymeric materials—Physical properties—Part 5: Determination of tensile strength, elongation at break and tear strength”.

It is preferable that the adhesive layer be formed by a double-sided tape, and a peeling adhesive strength of the adhesive layer be in a range of from 8 N/20 mm to 40 N/20 mm. Accordingly, while maintaining a good fixing strength of the sound-absorbing member, it is possible to easily perform a bonding operation of the sound-absorbing member and a disassembling operation at a time of disposing of the tire. The peeling adhesive strength of the double-sided tape is measured according to JIS-Z0237. More specifically, a double-sided adhesive sheet is backed with a PET (polyethylene terephthalate) film having a thickness of 25 μm. The backed adhesive sheet is cut into a rectangular shape of 20 mm×200 mm so as to create a test piece. A release liner is removed from the test piece, and an exposed adhering surface is attached to a stainless steel (SUS304, surface finishing BA) plate (adherend) by moving a roller of 2 kg back and forth once over the test piece. After keeping the test piece in an environment of 23° C. and RH 50% for 30 minutes, a 180 degrees peeling adhesive strength with respect to the SUS plate is measured according to JIS-Z0237, using a tensile tester in an environment of 23° C. and RH 50% and under conditions in which the peeling angle is set to 180 degrees and the tensile speed is set to 300 mm/minute.

### BRIEF DESCRIPTION OF DRAWINGS

FIG. 1 is a perspective cross-sectional view of a pneumatic tire according to an embodiment of the present technology.

FIG. 2 is a cross-sectional view along the equatorial line of the pneumatic tire according to the embodiment of the present technology.

FIG. 3 is a meridian cross-sectional view of a green tire in which a film has been attached to the inner surface of the green tire in a method for manufacturing the pneumatic tire of the present technology.

FIG. 4 is a perspective cross-sectional view of a vulcanized pneumatic tire in which the film has been removed from the inner surface of the vulcanized pneumatic tire in the method for manufacturing the pneumatic tire of the present technology.

FIGS. 5A and 5B illustrate a step of winding the film and an inner liner member around a molding drum in the method for manufacturing the pneumatic tire of the present technology; FIG. 5A is a side view of the step and FIG. 5B is a plan view thereof.

FIGS. 6A and 6B illustrate another step of winding the film and the inner liner member around the molding drum in the method for manufacturing the pneumatic tire of the present technology; FIG. 6A is a side view of the step and FIG. 5B is a plan view thereof.

FIG. 7 is a cross-sectional view along the equatorial line of a green tire in which the film has been attached to the inner surface of the green tire in the method for manufacturing the pneumatic tire of the present technology.

FIG. 8 is a cross-sectional view along the equatorial line of another green tire in which the film has been attached to the inner surface of the green tire in the method for manufacturing the pneumatic tire of the present technology.

FIG. 9 is a plan view of an example of a laminated body formed by the film and a rubber sheet that are used in the method for manufacturing the pneumatic tire of the present technology.

FIG. 10 is a plan view of a modified example of the laminated body formed by the film and the rubber sheet that are used in the method for manufacturing the pneumatic tire of the present technology.

### DETAILED DESCRIPTION

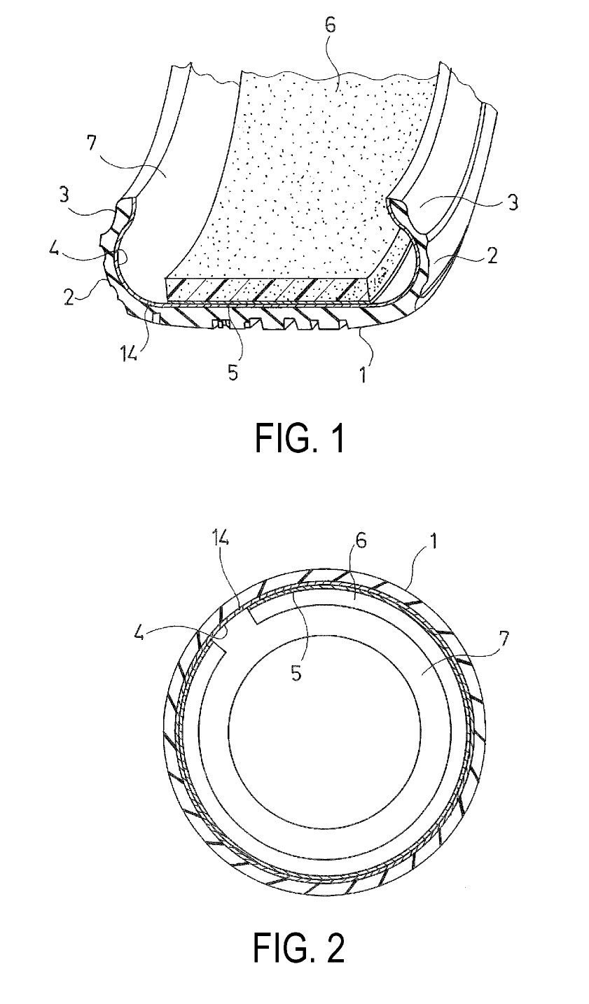

A configuration of the present technology will be described below in detail with reference to the accompanying drawings. FIGS. 1 and 2 illustrate a pneumatic tire according to an embodiment of the present technology. As illustrated in FIGS. 1 and 2, the pneumatic tire according to the present embodiment is provided with an annular-shaped tread portion 1 extending in the tire circumferential direction, a pair of side wall portions 2 disposed on both sides of the tread portion 1, and a pair of bead portions 3 disposed on inner sides of the side wall portions 2 in the tire radial direction.

In the above-described pneumatic tire, an inner liner layer 14 is disposed on a tire inner surface 4. The inner liner layer 14 is formed of a rubber composition and exhibits adhesiveness in a non-vulcanized state. A belt-shaped sound-absorbing member 6 is bonded to a region on the tire inner surface 4 corresponding to the tread portion 1, via an adhesive layer 5 along the tire circumferential direction. The sound-absorbing member 6 is formed of a porous material having interconnecting cells and has predetermined sound-absorbing characteristics based on the porous structure. Urethane foam is preferably used as the porous material of the sound-absorbing member 6. Meanwhile, as the adhesive layer 5, a paste adhesive or a double-sided adhesive tape can be used.

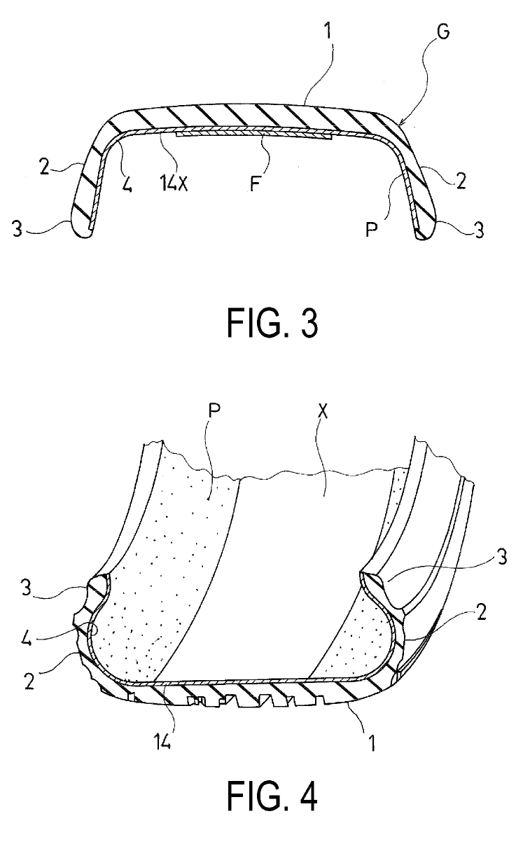

FIGS. 3 to 6B illustrate a method for manufacturing the pneumatic tire of the present technology. When the above-described pneumatic tire is manufactured, as illustrated in FIG. 3, a green tire G is prepared in which a film F has been attached to the region on the tire inner surface 4 corresponding to the tread portion 1, by an adhesive force of an inner liner member 14X. The inner liner member 14X is a member that becomes the inner liner layer 14 in the vulcanized pneumatic tire. Next, after coating the inner surface 4 of the green tire G provided with the film F with a mold release agent P, such as silicone oil, the green tire G coated with the mold release agent P is put into a mold, and the green tire G is vulcanized while an inner pressure is applied from the inner side of the green tire G using a bladder.

Next, as illustrated in FIG. 4, the film F is removed from the inner surface 4 of the pneumatic tire obtained as a result of the above-described vulcanization step, and the sound-absorbing member 6 is bonded to an exposed region X (a remainder of the film) from which the film F was peeled off via the adhesive layer 5 as illustrated in FIG. 1. By manufacturing the pneumatic tire provided with the sound-absorbing member 6 in this manner, it is possible to easily remove the mold release agent P from the region on the tire inner surface 4 to which the sound-absorbing member 6 is bonded. Accordingly, it is possible to inhibit an adhesive strength from being decreased due to the mold release agent P, and to suppress a separation of the sound-absorbing member 6 effectively. As a result, it is possible to maintain a noise reduction effect based on the sound-absorbing member 6 for a long period of time.

Examples of a method for preparing the green tire G having the film F attached to the region on the tire inner surface 4 corresponding to the tread portion 1 include the following three methods.

The first method is a method in which, after molding the green tire G, the film F is attached to the region on the inner surface 4 corresponding to the tread portion 1 of the green tire G without any adhesive but with the adhesive force of the inner liner member 14X, as illustrated in FIG. 3. Here, the molding of the green tire G means molding the green tire G having necessary tire components in the following steps:

molding a cylindrical molded carcass body including an inner liner member, a carcass member, a bead core, and a bead filler;

molding a tread ring including a belt member and a tread rubber member; and inflating the molded carcass body to a toroidal shape to press the molded carcass body against an inner circumferential surface of the tread ring.

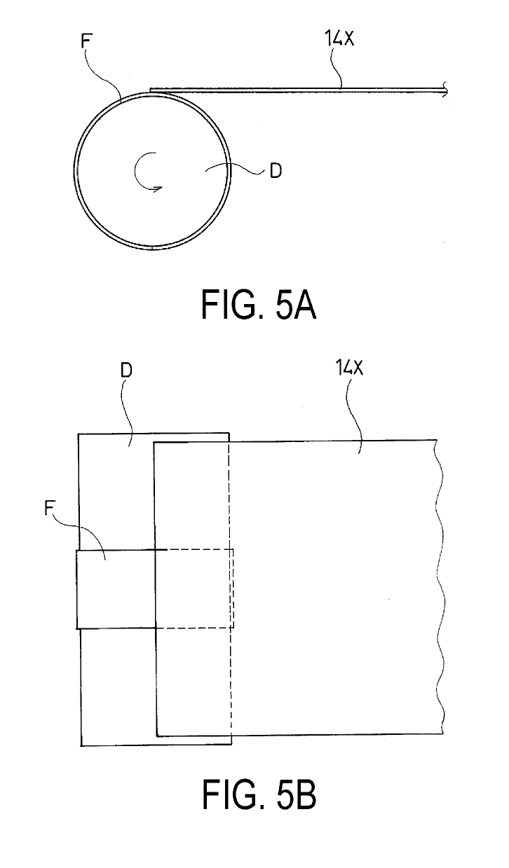

The second method is a method for molding the green tire G including the inner liner member 14X, which is layered so that the film F is positioned on the tire inner surface 4, by winding the film F around a molding drum D and winding the sheet-shaped inner liner member 14X onto the film F so as to attach the film F to a region on the inner liner member 14X corresponding to the tread portion 1 without any adhesive but with the adhesive force of the inner liner member 14X, as illustrated in FIGS. 5A and 5B. When the film F is attached to the inner liner member 14X in the molding step of the green tire G in this manner, it is possible to secure sufficient adhesiveness between the film F and the inner liner member 14X, and it is thus possible to inhibit the film F from being separated before the vulcanization step.

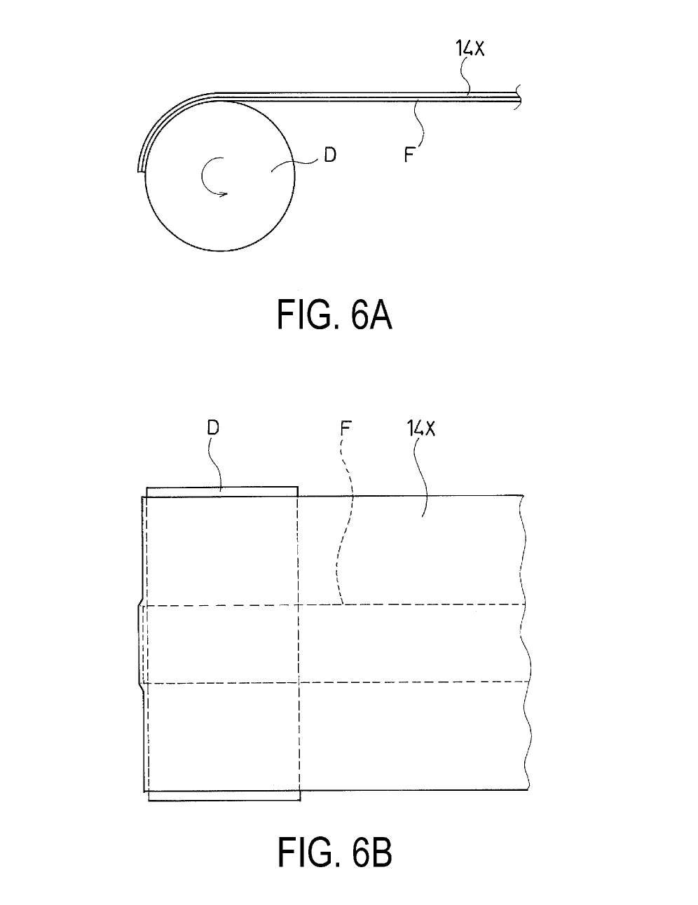

The third method is a method for molding the green tire G including the inner liner member 14X, which is layered so that the film F is positioned on the tire inner surface 4, by attaching the film F to the region on the sheet-shaped inner liner member 14X corresponding to the tread portion 1 in advance, without any adhesive but with the adhesive force of the inner liner member 14X, as illustrated in FIGS. 6A and 6B. When the film F is attached to the inner liner member 14X in the molding step of the green tire in this manner (particularly before being supplied to the molding drum D), it is possible to secure sufficient adhesiveness between the film F and the inner liner member 14X, and it is thus possible to inhibit the film F from being separated before the vulcanization step. Further, this method has the highest manufacturing efficiency.

A polymer forming the film F preferably contains nylon 6. The film F containing the nylon 6 has the best balance between adhesive strength with respect to the inner liner member 14X formed of unvulcanized rubber and ease of peeling after vulcanization. In particular, it is preferable that the polymer forming the film F be a single nylon 6 polymer. A tensile strength (ISO571) of the film F containing the nylon 6 is preferably 60 MPa or greater, and more preferably from 65 MPa to 150 MPa. By increasing the tensile strength of the film F, it is possible to inhibit the film F from being broken when the film F is peeled off after the vulcanization. Further, a tensile elongation at the breaking point (ASTM D-638) of the film F containing the nylon 6 is preferably 40% or greater, and more preferably from 50% to 400%. By increasing the tensile elongation at the breaking point, the film F can stretch while following a deformation of the tire in the molding step of the green tire G.

The thickness of the film F after the vulcanization is preferably from 10 μm to 120 μm. Accordingly, it is possible to achieve both the ease of peeling of the film F after the vulcanization, and the following capability of the film F with respect to the deformation of the tire that occurs during the molding step. When the thickness of the film F after the vulcanization is less than 10 μm, the film F is more easily broken when the film F is peeled off after the vulcanization. On the other hand, when the thickness is greater than 120 μm, it becomes difficult for the film F to stretch while following the deformation of the tire in the molding step of the green tire G. In particular, the thickness of the film F after the vulcanization is preferably from 20 μm to 90 μm.

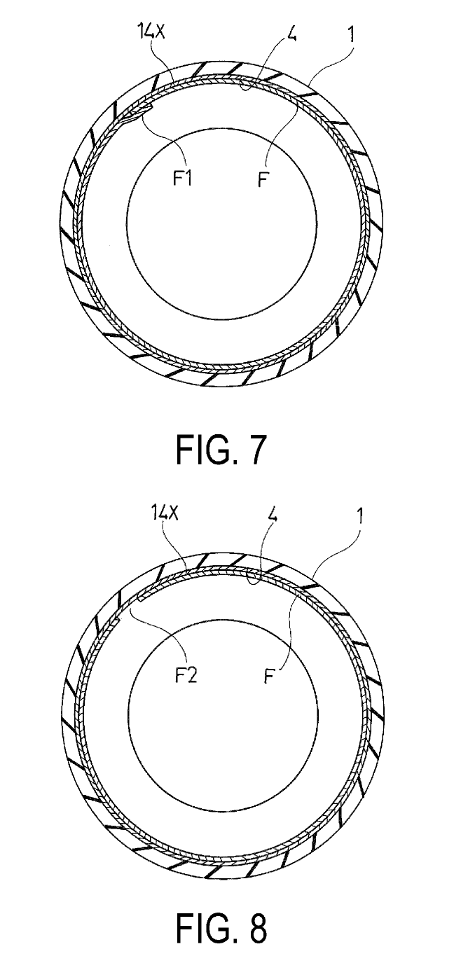

FIG. 7 illustrates the green tire G in which the film F is attached to the inner surface of the green tire G in the method for manufacturing the pneumatic tire of the present technology. As illustrated in FIG. 7, the film F is disposed so that the end portions of the film F in the tire circumferential direction overlap with each other, and the overlapping is maintained even after the vulcanization. In this case, because the end portions are overlapping with each other at a splice portion F1 of the film F, it is possible to reliably inhibit the mold release agent P from penetrating from the splice portion F1, and further, by grasping one of the overlapped end portions (the end portion positioned on the inner side in the tire radial direction), it is possible to easily perform a peeling-off operation of the film F after the vulcanization.

FIG. 8 illustrates another green tire G in which the film F is attached to the inner surface of the green tire G in the method for manufacturing a pneumatic tire of the present technology. As illustrated in FIG. 8, the film F is disposed so that a missing portion F2 is formed at at least one section in the tire circumferential direction before the vulcanization. In this case, the mold release agent P is locally attached to the missing portion F2. Then, when the sound-absorbing member 6 is bonded to the tire inner surface 4 so as to extend over the missing portion F2, the missing portion F2 becomes a non-adhering region despite the existence of the adhesive layer 5, and sections on both sides of the missing portion F2 in the tire circumferential direction become adhering regions. More specifically, by forming the missing portion F2 at the at least one section of the film F in the tire circumferential direction, the adhering region on the sound-absorbing member 6 can be divided in the tire circumferential direction. When radial growth occurs in the pneumatic tire, or when the tread portion 1 deforms, a shearing strain arises in an adhering surface of the sound-absorbing member 6. However, by dividing the adhesion region on the sound-absorbing member 6 in the tire circumferential direction, it is possible to alleviate the shearing strain arising in the adhering surface of the sound-absorbing member 6 and to suppress the separation of the sound-absorbing member 6.

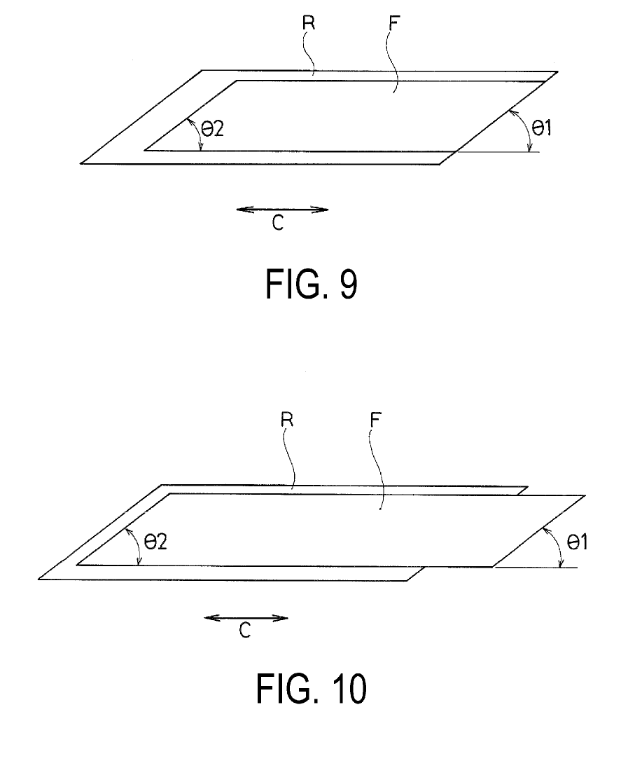

FIGS. 9 and 10 each illustrate a laminated body formed of the film F and a rubber sheet R that are used in the method for manufacturing a pneumatic tire of the present technology. In FIGS. 9 and 10, an arrow C indicates the tire circumferential direction. The film F may be used independently on its own, but, as illustrated in FIGS. 9 and 10, the film F may also be used in a state of being layered with the rubber sheet R. The rubber sheet R forms part of the inner liner member 14X. In FIG. 9, the film F and the rubber sheet R are layered so that one end of the film F and one end of the rubber sheet R are aligned with each other. However, in FIG. 10, the film F and the rubber sheet R are layered so that one end of the film F extends beyond the rubber sheet R.

As illustrated in FIGS. 9 and 10, cutting angles θ1 and θ2 at both the end portions of the film F in the tire circumferential direction are set to be within a range of from 50 degrees to 80 degrees with respect to the tire circumferential direction C. By inclining both the end portions of the film F with respect to the tire circumferential direction C in this manner, stress concentration, which arises at both the end portions of the film F when the green tire G deforms, is alleviated. As a result, it becomes easier for the film F to follow inflation during the molding step, and it is thus possible to maintain good adhesiveness of the film F. Here, when the cutting angles θ1 and θ2 are less than 50 degrees, the film F becomes longer than necessary, and as a result, productivity of the pneumatic tire deteriorates. On the other hand, when the cutting angles θ1 and θ2 exceed 80 degrees, the effect of alleviating the stress concentration deteriorates. In particular, the cutting angles θ1 and θ2 are preferably from 60 degrees to 70 degrees.

Further, the cutting angles θ1 and θ2 at both the end portions of the film F in the tire circumferential direction are preferably identical. More specifically, the film F obtained by cutting a long film material is supplied to the tire molding step. When the cutting angles θ1 and θ2 are made identical, it is possible to efficiently supply the film F that is cut with the identical cutting angles θ1 and θ2 at both the end portions in the tire circumferential direction, and it is thus possible to improve the productivity of the pneumatic tire.

In the above-described pneumatic tire, it is preferable that a single sound-absorbing member 6 extend in the tire circumferential direction, that the sound-absorbing member 6 have a uniform thickness at least over a range corresponding to the adhering surface along a cross-section orthogonal to the longitudinal direction of the sound-absorbing member 6, and that the shape of the cross section be constant in the longitudinal direction. In particular, although it is preferable that the cross-sectional shape of the cross section orthogonal to the longitudinal direction of the sound-absorbing member 6 be rectangular (including a square), in some cases, the shape may be an inverted trapezoid shape that becomes narrower on the adhering surface side. Accordingly, it is possible to maximize the volume of the sound-absorbing member 6 per adhering area and to obtain an excellent noise reduction effect. Further, because it is easy to process the sound-absorbing member 6 having the above-described shape, manufacturing costs are also low.

When the above-described pneumatic tire is assembled to the rim, a space 7 is formed between the tire inner surface 4 and the rim. A volume ratio of the sound-absorbing member 6 with respect to the volume of the space 7 is preferably greater than 20%. By making the volume of the sound-absorbing member 6 large in this manner, it is possible to achieve the excellent noise reduction effect, and further, it is possible to maintain a good adhering state for a long period of time even with the large sound-absorbing member 6. Note that the width of the sound-absorbing member 6 is preferably in a range of from 30% to 90% of the ground contact width of the tire. Further, the sound-absorbing member 6 preferably has a non-annular shape.

The hardness (JIS-K6400-2) of the sound-absorbing member 6 is preferably from 60 N to 170 N, and the tensile strength (JIS-K6400-5) of the sound-absorbing member 6 is preferably from 60 kPa to 180 kPa. The sound-absorbing member 6 that has the above-described physical properties has excellent durability with respect to the shearing strain. When the hardness or the tensile strength of the sound-absorbing member 6 is too small, this results in a deterioration in the durability of the sound-absorbing member 6. In particular, the hardness of the sound-absorbing member 6 is preferably from 70 N to 160 N, and more preferably from 80 N to 140 N. Further, the tensile strength of the sound-absorbing member 6 is preferably from 75 kPa to 165 kPa, and more preferably from 90 kPa to 150 kPa.

A peeling adhesive strength (JIS-Z0237:2009) of the adhesive layer 5 is preferably in a range of from 8 N/20 mm to 40 N/20 mm. Accordingly, while maintaining a good fixing strength of the sound-absorbing member 6, it is possible to easily perform an operation of attaching the sound-absorbing member 6 and a disassembling operation at a time of disposing of tire. More specifically, when a peeling force of the adhesive layer 5 is too weak, a fixed state of the sound-absorbing member 6 becomes unstable. On the other hand, when the peeling force of the adhesive layer 5 is too strong, it becomes difficult to change the attachment position during the attachment of the sound-absorbing member 6 and also to peel off the sound-absorbing member 6 at the time of disposing of tire. In particular, the peeling adhesive strength of the adhesive layer 5 is preferably from 9 N/20 mm to 30 N/20 mm, and more preferably from 10 N/20 mm to 25 N/20 mm.

### Examples

In order to manufacture a pneumatic tire of a tire size 275/35R20 that is provided with an annular-shaped tread portion extending in the tire circumferential direction, a pair of side wall portions disposed on both sides of the tread portion, and a pair of bead portions disposed on inner sides in the tire radial direction of the side wall portions, methods for manufacturing tires according to Comparative Examples 1 and 2, and Working Examples 1 to 8 were implemented under various manufacturing conditions.

In Comparative Example 1, a green tire provided with an inner liner member was molded, the inner surface of the green tire was coated with a mold release agent, and the green tire coated with the mold release agent was vulcanized. Then, a belt-shaped sound-absorbing member was bonded, via an adhesive layer along the tire circumferential direction, to a region, corresponding to a tread portion, on the inner surface of a pneumatic tire obtained through the vulcanization.

In Comparative Example 2, a green tire provided with an inner liner member was molded, the inner surface of the green tire was coated with a mold release agent, and the green tire coated with the mold release agent was vulcanized. Then, the mold release agent was wiped off with a cloth from a region, corresponding to a tread portion, on the inner surface of a pneumatic tire obtained through the vulcanization, and a belt-shaped sound-absorbing member was bonded, via an adhesive layer along the tire circumferential direction, to a region from which the mold release agent was wiped off.

In Working Examples 1, 6 and 7, a green tire provided with an inner liner member was molded, a film was attached to a region, corresponding to a tread portion, on the inner surface of the green tire by using an adhesive force of the inner liner member, the inner surface of the green tire including the film was coated with a mold release agent, and the green tire coated with the mold release agent was vulcanized. Then, the film was removed from the inner surface of a pneumatic tire obtained through the vulcanization, and a belt-shaped sound-absorbing member was bonded, via an adhesive layer along the tire circumferential direction, to an exposed region from which the film was peeled off. In Working Example 1, the polymer forming the film was a single nylon 6 (N6) polymer, and the thickness of the film was 50 μm. In Working Example 6, the polymer forming the film was a single polyethylene terephthalate (PET) polymer, and the thickness of the film was 50 μm. In Working Example 7, the polymer forming the film was a single nylon 66 (N66) polymer, and the thickness of the film was 50 μm.

In Working Examples 2, 3, 4 and 8, a film was disposed on a molding drum, a sheet-shaped inner liner member was wound around the film, the film was attached to a region, corresponding to a tread portion, on the inner liner member by using an adhesive force of the inner liner member, and a green tire was molded that includes the inner liner member in which the film is layered so as to be positioned on the inner surface of the tire. Then, the inner surface of the green tire including the film was coated with a mold release agent, and the green tire coated with the mold release agent was vulcanized. Further, the film was removed from the inner surface of a pneumatic tire obtained through the vulcanization, and a belt-shaped sound-absorbing member was bonded, via an adhesive layer along the tire circumferential direction, to an exposed region from which the film was peeled off. In Working Examples 2 and 8, the polymer forming the film was a single nylon 6 (N6) polymer, and the thickness of the film was 50 μm. In Working Example 3, the polymer forming the film was a single nylon 6 (N6) polymer, and the thickness of the film was 10 μm. In Working Example 4, the polymer forming the film was a single nylon 6 (N6) polymer, and the thickness of the film was 120 μm.

In Working Example 5, a film was attached to a region, corresponding to a tread portion, on a sheet-shaped inner liner member by using an adhesive force of the inner liner member, and a green tire was molded that includes the inner liner member in which the film is layered so as to be positioned on the inner surface of the tire. Then, the inner surface of the green tire including the film was coated with a mold release agent, and the green tire coated with the mold release agent was vulcanized. Further, the film was removed from the inner surface of a pneumatic tire obtained through the vulcanization, and a belt-shaped sound-absorbing member was bonded, via an adhesive layer along the tire circumferential direction, to an exposed region from which the film was peeled off. In Working Example 5, the polymer forming the film was a single nylon 6 (N6) polymer, and the thickness of the film was 50 μm.

Note that in Working Examples from 1 to 7, the cutting angles at both the end portions of the film were 80 degrees with respect to the tire circumferential direction. Meanwhile, in Working Example 8, the cutting angles at both the end portions of the film were 85 degrees with respect to the tire circumferential direction.

In Comparative Examples 1 and 2 and Working Examples 1 to 8, the following items were made common. The cross-sectional shape of the cross-section orthogonal to the longitudinal direction of the sound-absorbing member was rectangular, and the cross-sectional shape was made constant in the tire circumferential direction. The volume ratio of the sound-absorbing member with respect to the volume of the space formed inside the tire when the tire was assembled to the rim was 30%. The hardness of the sound-absorbing member was 91 N, and the tensile strength of the sound-absorbing member was 132 kPa. The peeling adhesive strength of the adhesive layer was 16 N/20 mm.

With respect to Comparative Examples 1 and 2 and Working Examples 1 to 8, according to the following evaluation method, the productivity of the tire and the adhesive peeling-off of the sound-absorbing member were evaluated. The evaluation results are shown in Table 1. Further, with respect to Working Examples 1 to 8, presence or absence of mixing in of the mold release agent was also evaluated. In addition, the adhesiveness and the ease of peeling of the film were evaluated according to the following evaluation method. The evaluation results are shown in Table 1.

### Tire Productivity:

In each of the manufacturing methods, a time required for all the steps, including the molding step, the vulcanization step, an adhering step of the sound-absorbing member, was measured. The evaluation results were indexed using the inverse of the measurement values, Comparative Example 1 being assigned an index value of 100. Larger index values indicate superior productivity.

### Adhesive Peeling-Off of Sound-Absorbing Member:

The pneumatic tire obtained by each of the manufacturing methods was assembled to a wheel having a rim size of 20×9.5 J. Then, the pneumatic tire underwent a 100-hour traveling test in a drum test machine under the conditions in which the air pressure was 150 kPa, the load was 6.9 kN, and the speed was 150 km/h. After that, the pneumatic tire was visually checked whether or not the adhesive peeling-off of the sound-absorbing member occurred.

### Film Adhesiveness:

In each of the manufacturing methods, the adhering state of the film with respect to the tire inner surface immediately before the vulcanization step was visually evaluated. The evaluation results indicate a case in which the film was entirely bonded to the tire inner surface as “A”, a case in which local separation was observed between the film and the tire inner surface as “B”, and a case in which separation from the tire inner surface was observed over a wide area of the film as “C”.

### Ease of Peeling of Film:

In each of the manufacturing methods, the ease of peeling of the film at the removal of the film from the inner surface of the vulcanized pneumatic tire was evaluated. The evaluation results indicate a case in which the film was easily peeled off as “A”, a case in which it was slightly difficult to peel off the film as “B”, and a case in which it was difficult to peel off the film as “C”.

TABLE 1

| | COMPARATIVE | COMPARATIVE | WORKING | WORKING | WORKING |
|---|---|---|---|---|---|
| | EXAMPLE 1 | EXAMPLE 2 | EXAMPLE 1 | EXAMPLE 2 | EXAMPLE 3 |
| REMOVAL | — | Wiping Off | Film | Film | Film |
| METHOD OF | | | (FIG. 3) | (FIG. 5) | (FIG. 5) |
| MOLD RELEASE | | | | | |
| AGENT | | | | | |
| FILM MATERIAL | — | — | N6 | N6 | N6 |
| FILM THICKNESS | — | — | 50 | 50 | 10 |
| (μm) | | | | | |
| FILM CUTTING | — | — | 80 | 80 | 80 |
| ANGLE (degrees) | | | | | |
| TIRE | 100 | 80 | 95 | 97 | 97 |
| PRODUCTIVITY: | | | | | |
| PRESENCE OF | Presence | Absence | Absence | Absence | Absence |
| ADHESIVE | | | | | |
| PEELING-OFF OF | | | | | |
| SOUND- | | | | | |
| ABSORBING | | | | | |
| MEMBER | | | | | |
| PRESENCE OF | — | — | Absence | Absence | Absence |
| MIXING IN OF | | | | | |
| MOLD RELEASE | | | | | |
| AGENT | | | | | |
| FILM | — | — | A | A | A |
| ADHESIVENESS | | | | | |
| EASE OF | — | — | A | A | B |
| PEELING OF | | | | | |
| FILM | | | | | |
| | WORKING | WORKING | WORKING | WORKING | WORKING |
| | EXAMPLE 4 | EXAMPLE 5 | EXAMPLE 6 | EXAMPLE 7 | EXAMPLE 8 |
| REMOVAL | Film | Film | Film | Film | Film |
| METHOD OF | (FIG. 5) | (FIG. 6) | (FIG. 3) | (FIG. 3) | (FIG. 5) |
| MOLD RELEASE | | | | | |
| AGENT | | | | | |
| FILM MATERIAL | N6 | N6 | PET | N66 | N6 |
| FILM THICKNESS | 120 | 50 | 50 | 50 | 50 |
| (μm) | | | | | |
| FILM CUTTING | 80 | 80 | 80 | 80 | 85 |
| ANGLE (degrees) | | | | | |
| TIRE | 97 | 99 | 97 | 96 | 97 |
| PRODUCTIVITY: | | | | | |
| PRESENCE OF | Absence | Absence | Absence | Absence | Absence |
| ADHESIVE | | | | | |
| PEELING-OFF OF | | | | | |
| SOUND- | | | | | |
| ABSORBING | | | | | |
| MEMBER | | | | | |
| PRESENCE OF | Absence | Absence | Presence | Presence | Absence |
| MIXING IN OF | | | | | |
| MOLD RELEASE | | | | | |
| AGENT | | | | | |
| FILM | B | A | B | A | B |
| ADHESIVENESS | | | | | |
| EASE OF PEELING | A | A | A | B | A |
| OF FILM | | | | | |

As shown in Table 1, the adhesive peeling-off of the sound-absorbing member notably occurred in the tire of Comparative Example 1. However, in Working Examples 1 to 8, the adhesive peeling-off of the sound-absorbing member was not observed at all. Further, Working Examples 1 to 8 resulted in small decreases in productivity compared with Comparative Example 1, but Comparative Example 2 resulted in a significant decrease in productivity.

Because the film was thin in Working Example 3, it was slightly difficult to peel off the film. In Working Example 4, because the film was thick and this made the film difficult to follow the deformation of the tire, the adhesiveness of the film with respect to the tire inner surface deteriorated slightly. In Working Example 6, because the film formed of polyethylene terephthalate was used, the adhesiveness of the film was poor. More specifically, the adhesive strength between the film and the inner liner member was weak, and the adhesiveness of the film deteriorated slightly. In Working Example 7, because the film formed of nylon 66 was used, the film had good adhesiveness, but because heat resistance of the film was slightly inferior to other examples, the film was softened. As a result, the ease of peeling of the film deteriorated slightly. In Working Example 8, because the cutting angle of the film was large, the adhesiveness of the film deteriorated slightly.

1. A method for manufacturing a pneumatic tire, the method comprising the steps of:
molding a green tire that includes an inner liner member;
attaching a film to a region on the inner surface of the green tire by adhesive force of the inner liner member, the region corresponding to a tread portion;
coating the inner surface of the green tire with a mold release agent, the green tire including the film;
vulcanizing the green tire coated with the mold release agent;
removing the film from the inner surface of a pneumatic tire obtained through the vulcanization; and
bonding a belt-shaped sound-absorbing member, via an adhesive layer along a tire circumferential direction, to an exposed region from which the film has been peeled off.

2. A method for manufacturing a pneumatic tire, the method comprising the steps of:
disposing a film on a molding drum;
winding a sheet-shaped inner liner member on the film and attaching the film to a region on the inner liner member by adhesive force of the inner liner member, the region corresponding to a tread portion;
molding a green tire that includes the inner liner member, the inner liner member being layered so that the film is positioned on a tire inner surface;
coating the inner surface of the green tire with a mold release agent, the green tire including the film;
vulcanizing the green tire coated with the mold release agent;
removing the film from the inner surface of a pneumatic tire obtained through the vulcanization; and
bonding a belt-shaped sound-absorbing member, via an adhesive layer along a tire circumferential direction, to an exposed region from which the film has been peeled off.

3. A method for manufacturing a pneumatic tire, the method comprising the steps of:
attaching a film to a region on a sheet-shaped inner liner member by adhesive force of the inner liner member, the region corresponding to a tread portion;
molding a green tire that includes the inner liner member, the inner liner member being layered so that the film is positioned on a tire inner surface;
coating the inner surface of the green tire with a mold release agent, the green ti re including the film;
vulcanizing the green tire coated with the mold release agent;
removing the film from the inner surface of a pneumatic tire obtained through the vulcanization; and
bonding a belt-shaped sound-absorbing member, via an adhesive layer along a tire circumferential direction, to an exposed region from which the film has been peeled off.

4. The method for manufacturing the pneumatic tire according to claim 1, wherein
a polymer forming the film contains nylon 6.

5. The method for manufacturing the pneumatic tire according to claim 1, wherein
the thickness of the film after the vulcanization is from 10 μm to 120 μm.

6. The method for manufacturing the pneumatic tire according to claim 1, wherein
end portions of the film in the tire circumferential direction are disposed so as to overlap with each other, and the overlapping is maintained even after the vulcanization.

7. The method for manufacturing the pneumatic tire according to claim 1, wherein
the film is disposed so as to form a missing portion at at least one section in the tire circumferential direction before the vulcanization.

8. The method for manufacturing the pneumatic tire according to claim 1, wherein
the sound-absorbing member is formed by one sound absorbing member extending in the tire circumferential direction, the sound-absorbing member having a uniform thickness at least over a range corresponding to an adhering surface along the cross section orthogonal to a longitudinal direction of the sound-absorbing member, and the shape of the cross section being constant in the longitudinal direction.

9. The method for manufacturing the pneumatic tire according to claim 1, wherein
a volume ratio of the sound-absorbing member with respect to a volume of a space formed inside the tire when the tire is assembled to a rim is larger than 20%.

10. The method for manufacturing the pneumatic tire according to claim 1, wherein
hardness of the sound-absorbing member is from 60 N to 170 N, and tensile strength of the sound-absorbing member is from 60 kPa to 180 kPa.

11. The method for manufacturing the pneumatic tire according to claim 1, wherein
the adhesive layer is formed by a double-sided tape, and peeling adhesive strength of the adhesive layer is in a range of from 8 N/20 mm to 40 N/20 mm.

12. The method for manufacturing the pneumatic tire according to claim 1, wherein
cutting angles at both the end portions of the film in the tire circumferential direction are from 50 degrees to 80 degrees with respect to the tire circumferential direction.

13. The method for manufacturing the pneumatic tire according to claim 1, wherein
the cutting angles at both the end portions of the film in the tire circumferential direction are identical.

14. The method for manufacturing the pneumatic tire according to claim 2, wherein
a polymer forming the film contains nylon 6.

15. The method for manufacturing the pneumatic tire according to claim 2, wherein
the thickness of the film after the vulcanization is from 10 μm to 120 μm.

16. The method for manufacturing the pneumatic tire according to claim 2, wherein
end portions of the film in the tire circumferential direction are disposed so as to overlap with each other, and the overlapping is maintained even after the vulcanization.

17. The method for manufacturing the pneumatic tire according to claim 2, wherein
the film is disposed so as to form a missing portion at at least one section in the tire circumferential direction before the vulcanization.

18. The method for manufacturing the pneumatic tire according to claim 3, wherein
a polymer forming the film contains nylon 6.

19. The method for manufacturing the pneumatic tire according to claim 3, wherein
the thickness of the film after the vulcanization is from 10 μm to 120 μm.

20. The method for manufacturing the pneumatic tire according to claim 3, wherein
end portions of the film in the tire circumferential direction are disposed so as to overlap with each other, and the overlapping is maintained even after the vulcanization.
